(19) United States
(12) Patent Application Publication
(10) Pub. No.: US 2006/0077692 A1
(43) Pub. Date: Apr. 13, 2006

(54) Backlight unit and liquid crystal display apparatus employing the same

(76) Inventors: Ji-whan Noh, Suwan-si (KR); Kye-hoon Lee, Suwan-si (KR)

Correspondence Address: STANZIONE & KIM, LLP, 919 18TH STREET, N.W., SUITE 440, WASHINGTON, DC, 20006, US

(21) Appl. No.: 11/231,929

(22) Filed: Sep. 22, 2005

(30) Foreign Application Priority Data
Sep. 25, 2004 (KR) 2004-77596

(51) Int. Cl. F21V 7/04

(52) U.S. Cl. 362/625

(57) ABSTRACT

A backlight unit and a liquid crystal display (LCD) apparatus employing the backlight unit. The backlight unit includes a plurality of light-emitting device units disposed on a base plate in an array, each light-emitting device unit including a collimator to collimate light emitted by a light-emitting device so that the light propagates in a principal propagation direction of light emitted from light-emitting device, a plurality of side reflectors disposed in an array above the array of corresponding light-emitting device units and to reflect lateral light incident from the corresponding light-emitting device units, a reflective diffusion plate to reflect and diffuse light incident from the side reflectors, and a transmissive diffusion plate that is disposed above the light-emitting device units, to transmit and diffuse the incident and reflected light.

### CROSS-REFERENCE TO RELATED APPLICATIONS

This application claims the benefit of priority under U.S.C. § 119 from Korean Patent Application No. 2004-77596, filed on Sep. 25, 2004, in the Korean Intellectual Property Office, the disclosure of which is incorporated herein in its entirety by reference.

### BACKGROUND OF THE INVENTION

1. Field of the Invention

The present general inventive concept relates to a backlight unit and a liquid crystal display apparatus employing the same.

2. Description of the Related Art

A liquid crystal display (LCD) is a non-emissive flat panel display that needs external light to display an image since the LCD itself does not emit light. A backlight unit is located behind the LCD to illuminate it.

Backlight units are classified into a direct light type backlight unit and an edge light type backlight unit according to a position of a light source. In the case of the direct light type backlight unit, a plurality of light sources disposed beneath the LCD emits light directly toward the LCD panel. In the case of the edge light type backlight unit, a light source located along an edge of a light guide panel (LGP) emits light toward the LCD panel via the LGP.

The direct light type backlight unit may use light emitting diodes (LEDs) that emit Lambertian radiation as a point light source.

Conventionally, a backlight unit with a transmissive diffusion plate and a reflective diffusion plate and disposed above and below LEDs, respectively, include reflecting mirrors disposed above the LEDs to prevent light emitted from the LED from being directly visible above the transmissive diffusion plate. Light emitted from the LEDs and then reflected by the reflecting mirror tends not to spread out widely and uniformly. Thus, to spread out the light over a broader area, the distance between the LEDs and the transmissive diffusion plate is increased, which results in a thicker backlight unit, and, nevertheless, poor uniformity of light distribution.

### SUMMARY OF THE INVENTION

The present invention provides a thin backlight unit with improved uniformity of light distribution, and a liquid crystal display (LCD) apparatus employing the same.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a backlight unit including: a plurality of light-emitting device units disposed on a base plate in an array, each light-emitting device unit including a collimator to collimate light emitted by a light-emitting device so that light propagates in a principal propagation direction, a plurality of side reflectors disposed in the principal propagation direction opposite to the corresponding light-emitting device units to reflect in lateral directions light incident from the corresponding light-emitting device units, a reflective diffusion plate to reflect and diffuse the light reflected by the side reflectors, and a transmissive diffusion plate that is disposed behind the light-emitting device units in the principal propagation direction, to transmit and diffuse the incident and reflected light.

The collimator may include a transparent body, a reflecting surface formed on an outside surface of the transparent body, to reflect light emitted from the light-emitting device, and a lens portion formed in a center of the transparent body, to refract the incident light.

The reflecting surface may have a parabolic shape or a conical shape. The lens portion may have a curved surface to serve as a convex lens.

The side reflector may be conical or curved cone shaped to uniformly reflect light in the lateral directions. The side reflectors may be disposed on one surface of the transmissive diffusion plate.

Each of the light-emitting device units may emit one of red, green, and blue color beams or white light. The backlight unit may further include at least one of a brightness enhancement film (BEF) to improve directivity of the light traveling in the principal propagation direction. The backlight unit may also include polarization enhancement film to increase an efficiency of polarization of the light traveling in the principal propagation direction.

The foregoing and other aspects of the present general inventive concept may also be achieved by providing a LCD apparatus including: a liquid crystal panel and the backlight unit having a plurality of light-emitting device units disposed on a base plate in an array, each light-emitting device unit including a collimator to collimate light emitted by a light-emitting device so that the light propagates in a principal propagation direction, a plurality of side reflectors disposed in an array above the array of corresponding light-emitting device units, to reflect in lateral directions the light incident from the corresponding light-emitting device units, a reflective diffusion plate to reflect and diffuse light reflected by the side reflectors, and a transmissive diffusion plate that is disposed above the light-emitting device units, to transmit and diffuse the incident and reflected light toward the liquid crystal panel.

The foregoing and other aspects of the present general inventive concept may also be achieved by a method of providing a backlight to a panel, the method including emitting light by an array of light-emitting device units disposed on a base plate in an array, each light-emitting device unit including a collimator to collimate light emitted by a light-emitting device so that the light propagates in a principal propagation direction, reflecting in lateral directions the light incident from the light-emitting units, by a plurality of side reflectors disposed above each light-emitting device unit, reflecting and diffusing the lateral reflected light, and transmitting and diffusing the light in the principal propagation direction.

The foregoing and other aspects of the present general inventive concept may also be achieved by providing a backlight unit including a base plate, a reflective diffusing plate formed on the base plate, a plurality of light-emitting device units disposed on the reflective diffusing plate and spaced apart from each other to emit light in a principal propagation direction, a transmission diffusion plate spaced apart from the reflecting diffusing plate, and a plurality of side reflectors formed on the transmissive diffusion plate to reflect the light from each of corresponding light-emitting device units, in lateral directions.

The foregoing and other aspects of the present general inventive concept may also be achieved by providing a method to form a backlight unit including forming a base plate, forming a reflective diffusing plate formed on the base plate, placing a plurality of light-emitting device units on the reflective diffusing plate, spaced apart from each other, the light-emitting device units emitting light in a principal propagation direction, forming a transmission diffusion plate spaced apart from the reflecting diffusing plate, and forming a plurality of side reflectors formed on the transmissive diffusion plate to reflect the light from each of corresponding light-emitting device units, in lateral directions.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view of a backlight unit according to an embodiment of the present general inventive concept;

FIG. 2 is an enlarged view of a light emitting device of the backlight unit of FIG. 1;

FIG. 3 is a perspective view of a collimator and corresponding side reflector of the backlight unit of FIG. 1; and

FIG. 4 schematically shows a liquid crystal display (LCD) apparatus including the backlight unit of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

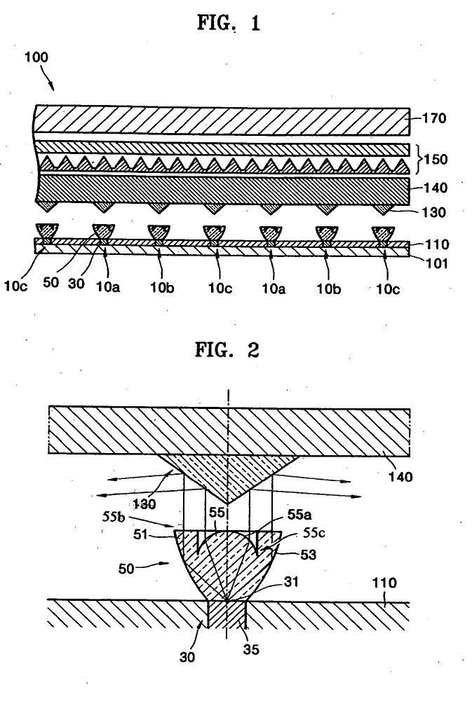

Referring to FIGS. 1-3, a backlight unit 100 according to an embodiment of the present general inventive concept includes an array of light-emitting device units 10a, 10b, and 10c disposed on a base plate 101 to emit light in a principal propagation direction, an array of side reflectors 130 disposed above the array of light-emitting device units 10a, 10b, and 10c to reflect light incident from the light-emitting device units 10a, 10b, and 10c in lateral directions having non-zero angles with the principal propagation direction, a reflective diffusion plate 110 disposed below the light-emitting device units 10a, 10b, and 10c to reflect and diffuse incident light, and a transmissive diffusion plate 140 disposed above the light-emitting device units 10a, 10b, and 10c to transmit and diffuse incident light.

Here, the term ‘above’ refers to the principal propagation direction of the light emitted from a light-emitting device 30 in each of the light-emitting device units 10a, 10b, and 10c, while the term ‘below’ refers to a reverse direction of the principal propagation direction. The principal propagation direction of the light substantially corresponds to a central axis of each of the light-emitting device units 10a, 10b, and 10c, i.e., the direction in which the light emitted from the light-emitting device unit 10a, 10b, or 10c propagate along a line parallel to the central axis thereof.

The base plate 101 serves as a substrate on which the plurality of light-emitting device units 10a, 10b, and 10c are arranged in a two-dimensional array. The base plate 101 may be a printed circuit board (PCB) to drive a light-emitting diode (LED) chip 31 in each of the light-emitting device units 10a, 10b, and 10c. Alternatively, the base plate 101. may be spaced apart from a PCB to drive the light-emitting device units 10a, 10b, and 10c separately.

Each of the light-emitting device units 10a, 10b, and 10c includes the light-emitting device 30 to emit light and a collimator 50 to collimate the Lambertian light from the light-emitting device 30 so that the light propagates upwardly. The light-emitting device 30 includes the LED chip 31 to generate light and the corresponding collimator 50. The LED chip 31 is mounted on a base 35. The LED chip 31 may adhere closely to the collimator 50 to maximize the amount of light that is emitted by the LED chip 31 into the collimator 50.

The light-emitting device units 10a, 10b, and 10c may emit red (R), green (G), and blue (B) color beams. In this case, the light-emitting device units 10a, 10b, and 10c include the LED chips 31 to generate R, G, and B color beams, respectively. Alternatively, the light-emitting device units 10a, 10b, and 10c may all emit white light. In this case, each of the light emitting device units 10a, 10b, and 10c includes the LED chip 31 to generate white light.

An LCD apparatus employing the backlight unit 100 can display a color image if the light-emitting device units 10a, 10b, and 10c use LED chips generating R, G, and B color beams.

Although the light-emitting device units 10a, 10b, and 10c are separate from each other as shown in FIG. 1, the light-emitting device units 10a, 10b, and 10c may all emit white light.

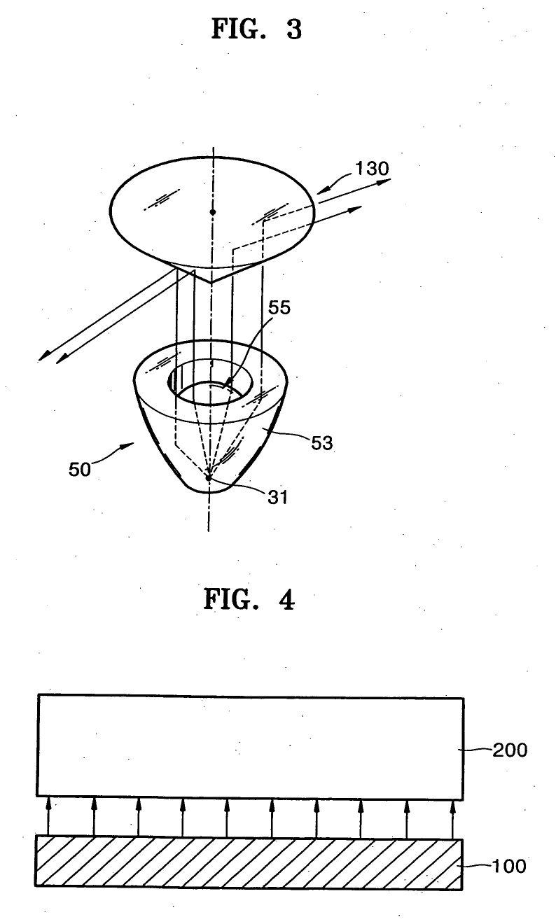

The collimator 50 includes a transparent body 51, a reflecting surface 53 to form on an outside of the transparent body 51 to reflect light emitted from the LED chip 31 upwards, and a lens portion 55 that is formed in a center of an upper portion the body 51 and converges and refracts incident light upward, as shown in FIGS. 2 and 3.

The reflecting surface 53 may have a parabolic shape or a conical shape. The reflecting surface 53 may be a mirror. When the reflecting surface has the parabolic shape, the divergent light emitted by the point-like light source (LED chip 31) and then reflected from the reflecting surface 53 is collimated into a substantially parallel light. When the reflecting surface 53 is conical, the light reflected by the reflecting surface 53 is also a substantially parallel beam. When the reflecting surface 53 has a parabolic shape or conical shape, the incident light is reflected upward from the reflecting surface 53, the reflected light being substantially parallel.

The lens portion 55 may have a curved surface 55a to serve as a convex lens. Since light emitted from the LED chip 31 spreads out, the curved surface 55a of the lens portion 55 causes the incident diverging light to converge and be collimated into substantially parallel light. A major output surface of the collimator may include a curved portion 55a and a flat portion 55b. The light emerging from the flat portion 55b is incident on a first area of the side reflector 130, and the light emerging from the curved surface 55a is incident on a second area of the side reflector 130. A groove 55c between the flat collimator surface and the curved collimator surface prevents light emitted by the LED 30 to exit the collimator directly through the flat surface, unless the light was reflected by the collimator's reflecting surface 53.

The collimator 50 converts the diverging light generated from the LED chip 31 into substantially parallel light that is then incident on the side reflector 130.

The side reflectors 130 corresponding to the light-emitting device units 10a, 10b, and 10c are arranged in a two-dimensional array. The side reflectors 130 spread the light incident from the collimator 50 of the light-emitting device units 10a, 10b, and 10c in lateral directions. The side reflectors 130 may be conical or curved cone shaped to uniformly reflect light incident from the collimator 50 in the lateral directions. In FIGS. 1 and 2, the array of the side reflectors 130 are arranged on the transmissive diffusion plate 140, but the side reflectors may be disposed on a separate transparent plate (not shown).

As described above, the backlight unit 100 including the light-emitting device units 10a, 10b, and 10c, each having the collimator 50, and the side reflectors 130 allows most of light emitted from the light-emitting device units 10a, 10b, and 10c to spread out over a wide area before entering the reflective diffusion plate 110, thereby providing uniform brightness distribution.

The side reflectors 130 prevent transmission of a light spot located at the position of the LED chip 31 or the color of the LED chip 31 emitting a color beam, above the backlight unit 100.

Meanwhile, the reflective diffusion plate 110 reflects and diffuses light reflected by the side reflector 130 so that the reflected light propagates upward.

The reflective diffusion plate 110 is disposed on the base plate 101 at the bottom of the light-emitting device units 10a, 10b, and 10c. The reflective diffusion plate 110 has a plurality of holes in which the light-emitting devices 30 of the plurality of light-emitting device units 10a, 10b, and 10c are respectively disposed. The reflective diffusion plate 110 is disposed on the base plate 101 with the light-emitting devices 30 being inserted into the plurality of holes.

The transmissive diffusion plate 140 reflects and diffuses incident light. As shown in FIGS. 1 and 2, the side reflectors 130 may be disposed on a bottom surface the transmissive diffusion plate 140.

In the backlight unit 100, the collimated beams are emitted from the light-emitting device units 10a, 10b, and 10c and reflected in the lateral directions by the side reflectors 130 disposed above the light-emitting device units 10a, 10b, and 10c, which causes the beams to spread out widely before entering the reflective diffusion plate 110. Thus, the backlight unit 100 has a reduced thickness over a conventional backlight unit because light can be distributed uniformly although a distance between the light-emitting device units 10a, 10b, and 10c and the transmissive diffusion plate 140 is small.

Meanwhile, the backlight unit 100 further includes a brightness enhancement film (BEF) 150 to improve the directivity of light beams escaping from the transmissive diffusion plate 140, and a polarization enhancement film 170 to increase polarization efficiency.

The BEF 150 is used to refract and condense light beams that escape from the transmissive diffusion plate 140, thereby increasing the directivity and thereby brightness of the light beams. The polarization enhancement film 170 transmits one polarized light beam, e.g., a p-polarized light beam while reflecting the other polarized beam, e.g., an s-polarized light beam. Thereby, after passing through the polarization enhancement film 170, most of incident light beams are linearly polarized, with one polarization direction, e.g., the p-polarized light.

A liquid crystal display (LCD) apparatus employing the backlight unit 100 may include a liquid crystal panel disposed above the backlight unit 100. When a linearly polarized beam is incident on a liquid crystal layer in a liquid crystal panel, the polarization of the light passing through the liquid crystal layer is rotated if an electric field is applied to the liquid crystal layer, thereby enabling image information to be displayed on the liquid crystal panel. Although this embodiment describes the liquid crystal layer through which a polarized light beam passes, the present general inventive concept is not limited thereto.

The efficiency of light utilization may be improved when light incident on a liquid crystal panel has single polarization. Therefore, using the polarization enhancement film 170 for the backlight unit 100 may increase optical efficiency.

As described above, the backlight unit 100 includes light-emitting device units 10a, 10b, and 10c to collimate light emitted from an array of point light sources so that the collimated light propagates upward; the side reflectors 130 reflect incident light in such a manner that they spread out more widely before reaching the reflective diffusion plate 110. The backlight unit 100 having the above configuration is thin while providing uniform light distribution across the entire surface.

Thus, a LCD apparatus employing the backlight unit 100 enables the display of high quality image with uniform brightness across the entire screen.

FIG. 4 schematically shows a LCD apparatus including the backlight unit 100. Referring to FIG. 4, the LCD apparatus includes the backlight unit 100 and a liquid crystal panel 200 disposed above the backlight unit 100. The liquid crystal panel 200 is coupled to a driving circuitry (not shown). Since the detailed configuration of the liquid crystal panel 200 and display operation using the driving circuitry are widely known in the art, their description will not be given.

The present invention provides a thin backlight unit capable of providing uniform light distribution. The present invention also provides a LCD apparatus employing the backlight unit producing a high quality image with uniform brightness across the entire screen.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A backlight unit comprising:
a plurality of light-emitting device units disposed on a base plate in an array, each light-emitting device unit including a collimator to collimate light emitted by a light-emitting device so that the light propagates in a principal propagation direction;
a plurality of side reflectors disposed in the principal propagation direction opposite to the corresponding light-emitting device units, to reflect the light incident from the corresponding light-emitting device units in lateral directions;
a reflective diffusion plate to reflect and diffuse the light reflected by the side reflectors; and
a transmissive diffusion plate that is disposed behind the light-emitting device units in the principal propagation direction, to transmit and diffuse the incident and reflected light.

2. The backlight unit of claim 1, wherein the collimator comprises:
a transparent body;
a reflecting surface formed on an outside surface of the transparent body, reflecting light emitted from the light-emitting device; and
a lens portion formed in a center of the transparent body, to reflect incident light.

3. The backlight unit of claim 2, wherein the reflecting surface has a parabolic or a conical shape.

4. The backlight unit of claim 2, wherein the lens portion has a curved surface to serve as a convex lens.

5. The backlight unit of claim 2, wherein the side reflector is conical or curved cone shaped to uniformly reflect the light in the lateral directions.

6. The backlight unit of claim 2, wherein the side reflectors are disposed on a surface of the transmissive diffusion plate.

7. The backlight unit of claim 1, wherein the side reflector is conical or curved cone shaped to uniformly reflect light beams in the lateral directions.

8. The backlight unit of claim 1, wherein the side reflectors are disposed on a surface of the transmissive diffusion plate.

9. The backlight unit of claim 1, wherein each of the light-emitting device units emits one of red, green, and blue color beams or white light.

10. The backlight unit of claim 1, further comprising:
at least one of a brightness enhancement film (BEF) to improve directivity of the light traveling in the principal propagation direction; and
a polarization enhancement film to increase an efficiency of polarization of the light traveling in the principal propagation direction.

11. A liquid crystal display apparatus comprising:
a liquid crystal panel; and
a backlight including:
a plurality of light-emitting device units disposed on a base plate in an array, each light-emitting device unit including a collimator to collimate light emitted by a light-emitting device so that the light propagates in a principal propagation direction,
a plurality of side reflectors disposed in an array above the array of corresponding light-emitting device units, to reflect in lateral directions the light incident from the corresponding light-emitting device units,
a reflective diffusion plate to reflect and diffuse light reflected by the side reflectors, and
a transmissive diffusion plate that is disposed above the light-emitting device units, to transmit and diffuse the incident and reflected light toward the liquid crystal panel.

12. The apparatus as in claim 11, wherein the collimator comprises:
a transparent body;
a reflecting surface that is formed on the outside surface of the transparent body and reflects the light emitted from the light-emitting device in the principal propagation direction; and
a lens portion that is formed in a center of the transparent body and refracts the incident light in the principal propagation direction.

13. The apparatus of claim 12, wherein the reflecting surface has a parabolic or conical shape.

14. The apparatus of claim 12, wherein the lens portion has a curved surface to serve as a convex lens.

15. The apparatus of claim 12, wherein the side reflector is conical or curved cone shaped to uniformly reflect the light in the lateral directions.

16. The apparatus of claim 12, wherein the side reflectors are disposed on a surface of the transmissive diffusion plate.

17. The apparatus of claim 11, wherein the side reflector is conical or curved cone shaped to uniformly reflect light beams in the lateral directions.

18. The apparatus of claim 11, wherein the side reflectors are disposed on a surface of the transmissive diffusion plate.

19. The apparatus of claim 11, wherein the liquid panel displays a color image, and each of the light-emitting device units emits one of red, green, and blue color beams or white light.

20. The apparatus of claim 11, wherein the backlight unit further comprises:
at least one of a brightness enhancement film (BEF) to improve directivity of the light escaping from the transmissive diffusion plate; and
a polarization enhancement film to increase efficiency of light polarization.

21. A method of providing a backlight to a panel, the method comprising:
emitting light by an array of light-emitting device units disposed on a base plate in an array, each light-emitting device unit including a collimator to collimate light emitted by a light-emitting device so that the light propagates in a principal propagation direction;
reflecting in lateral directions the light incident from the light-emitting units, by a plurality of side reflectors disposed above each light-emitting device unit;
reflecting and diffusing the lateral reflected light; and
transmitting and diffusing the light in the principal propagation direction.

22. A backlight unit comprising:
a base plate;
a reflective diffusing plate formed on the base plate;
a plurality of light-emitting device units disposed on the reflective diffusing plate and spaced apart from each other to emit light in a principal propagation direction;
a transmission diffusion plate spaced apart from the reflecting diffusing plate; and
a plurality of side reflectors formed on the transmissive diffusion plate to reflect the light from corresponding ones of the plurality of light-emitting device units, in a lateral direction.

23. The backlight of claim 22, wherein each of the plurality of light-emitting device units comprises:
a base;
a LED disposed on the base to emit the light; and
a collimator disposed on the base and LED to collimate the light toward the corresponding side reflector.

24. The backlight of claim 23, wherein the collimator comprises:
a reflecting surface to reflect the emitted light; and
a major surface to output the collimated light and the emitted light toward the corresponding side reflector.

25. The backlight of claim 24, wherein the major surface comprises a curved portion and a flat portion.

26. The backlight of claim 25, wherein a surface of each side reflectors comprises a first area to reflect the light from the flat portion of the major surface, and a second area to reflect the light from the curved portion of the major surface, respectively.

27. The backlight of claim 25, wherein the light-emitting device comprises a first light and a second light, and the collimator collimates the first light through the reflecting surface and the flat surface and the collimator collimates the second light through the curved surface.

28. The backlight of claim 24, wherein the collimator comprises a groove formed by the curved portion and a plane of the flat portion to prevent the light emitted from the LED to output directly through the flat surface.

29. The backlight of claim 24, wherein the reflecting surface forms an outer-side surface of the collimator between the major surface and the reflective diffusing plate to reflect the light.

30. The backlight of claim 22, further comprising:
a brightness enhancement film disposed on the transmissive diffusion plate opposite to the plurality of side reflectors to improve directivity of light propagating in the principal propagation direction; and
a polarization enhancement film disposed on the brightness enhancement film opposite to the transmissive diffusion plate to improve select light with one polarization direction.

31. A method to form a backlight unit comprising:
forming a base plate;
forming a reflective diffusing plate formed on the base plate;
placing a plurality of light-emitting device units on the reflective diffusing plate to be spaced apart from each other so that the light-emitting device units emit light in a principal propagation direction;
forming a transmission diffusion plate to be spaced apart from the reflecting diffusing plate; and
forming a plurality of side reflectors formed on the transmissive diffusion plate to reflect the light from each of corresponding light-emitting device units, in lateral directions.
